(19) United States
(12) Patent Application Publication
(10) Pub. No.: US 2005/0099107 A1
(43) Pub. Date: May 12, 2005

(54) Surface light source device, method of manufacturing the same and display apparatus having the same

(76) Inventors: Seock-Hwan Kang, Suwon-si (KR); Sang-Yu Lee, Yongin-si (KR); Gi-Chang Park, Seoul (KR)

Correspondence Address: MCGUIREWOODS, LLP, 1750 TYSONS BLVD, SUITE 1800, MCLEAN, VA, 22102, US

(21) Appl. No.: 10/985,004

(22) Filed: Nov. 10, 2004

(30) Foreign Application Priority Data
Nov. 11, 2003 (KR) 2003-79485

(51) Int. Cl. H01J 1/62; H01J 63/04

(52) U.S. Cl. 313/292; 313/634; 313/495

(57) ABSTRACT

A surface light source device includes a body, a partition member and a visible light generating unit. The body includes first and second substrates. The first substrate has a first discharge region, a first space diving region alternately formed with the first discharge region and a light transmission portion protruded from the first space dividing region. The second substrate faces the first substrate. The partition member is interposed between the first and second substrates to form a discharge space between the first and second substrates. The visible light generating unit disposed at the body generates a visible light. Therefore, dark lines displayed in a conventional display apparatus due to partition members are converted into bright lines, and the bright lines are diffused by the light diffusing patterns or the light diffusing part. Therefore, a luminance and a uniformity of the luminance are enhanced.

### CROSS-REFERENCE TO RELATED APPLICATIONS

This application relies for priority upon Korean Patent Application No. 2003-79485 filed on Nov. 11, 2003, the contents of which are herein incorporated by reference in its entirety.

### BACKGROUND OF THE INVENTION

1. Field of the Invention

The present invention relates to a surface light source device, a method of manufacturing the surface light source device and a display apparatus having the surface light source device. More particularly, the present invention relates to a surface light source device having enhanced luminance and uniformity of the luminance, a method of manufacturing the surface light source device and a display apparatus having the surface light source device.

2. Description of the Related Art

Generally, display apparatuses convert data processed by information processing apparatus into an image. A liquid crystal display (LCD) apparatus as one of the display apparatuses displays an image by using liquid crystal.

The liquid crystal has specific electrical and optical characteristics. That is, when electric fields are applied to the liquid crystal, an arrangement of liquid crystal molecules is changed to adjust optical transmittance.

The LCD apparatus uses the above-mentioned electrical and optical characteristics in order to display an image. The LCD apparatus has many merits such as small volume, lightweight, etc. Therefore, the LCD apparatus is widely used for various electronics such as a mobile computer, a telecommunication device, an LCD television set, etc.

The LCD apparatus includes a liquid crystal control part and a light providing part.

The liquid crystal control part includes a pixel electrode formed on a first substrate, a common electrode formed on a second substrate and a liquid crystal interposed between the pixel electrode and the common electrode. The first substrate includes a plurality of the pixel electrodes. The number of the pixel electrode is determined according to resolution. A number of the common electrode is, for example, one. The pixel electrode is electrically connected to a thin film transistor, and a pixel voltage is applied to the pixel electrode through the thin film transistor. A reference voltage is applied to the common electrode. Therefore, electric fields are generated between the pixel electrode and the common electrode. The pixel electrode and the common electrode of an LCD apparatus that requires the light providing part include optically transparent and electrically conductive material such as indium tin oxide (ITO), indium zinc oxide (IZO), etc.

The light providing part provides the liquid crystal control part with a light. Since the light generated from the light providing part passes through the pixel electrode, liquid crystal and common electrode in sequence to display an image, a display quality is influenced by a uniformity of the light.

A conventional light providing part employs a cold cathode fluorescent lamp (CCFL) or a light emitting diode (LED). The CCFL has many merits such as a high luminance, a long lifespan, etc. Furthermore, the CCFL generates a white light and has lower power consumption than that of a glow lamp. The LED has low power consumption and a high luminance.

However, both of the CCFL and the LED have a low uniformity of luminance.

Therefore, in order to enhance the uniformity of luminance, the light providing part employing the CCFL or the LED requires various optical members such as a light guide plate, a diffusion member and prism sheet, etc. Therefore, volumes, weight and manufacturing cost of the LCD apparatus increase.

### SUMMARY OF THE INVENTION

The present invention provides a surface light source device having enhanced luminance and uniformity of the luminance.

The present invention also provides a method suitable of manufacturing the above-mentioned surface light source device.

The present invention also provides a display apparatus having the above-mentioned surface light source device.

In an exemplary surface light source device according to the present invention, the surface light source device includes a body, a partition member and a visible light generating unit. The body includes first and second substrates facing each other. The first substrate has a first discharge region, a first space diving region alternately formed with the first discharge region and a light transmission portion protruded from the first space dividing region. The second substrate has a second discharge region and a second space dividing region facing the first discharge region and the first space dividing region, respectively. The partition member is interposed between the first and second substrates to form a discharge space therebetween. The visible light generating unit disposed at the body generates a visible light.

In another exemplary surface light source device according to the invention, the surface light source device includes a body, a partition member and a visible light generating unit. The body includes first and second substrates facing each other. The first substrate has a first discharge region and a first space diving region alternately formed with the first discharge region. The first discharge region is recessed to form a light transmission portion at the first space dividing region. The second substrate has a second discharge region and a second space dividing region facing the first discharge region and the first space dividing region, respectively. The partition member is interposed between the first and second substrates to form a discharge space therebetween. The visible light generating unit disposed at the body generates a visible light.

In an exemplary method of manufacturing a surface light source device, a first substrate including a first discharge region, a first space diving region alternately formed with the first discharge region and a light transmission portion protruded from the first space dividing region is formed. A second substrate including a second discharge region and a second space dividing region facing the first discharge region and the first space dividing region, respectively, is formed. A partition member that forms a discharge space between the light transmission portion and the second space dividing region is formed. Then, the first and second substrates are assembled such that the light transmission portion makes contact with the partition member.

In another exemplary method of manufacturing a surface light source device, a first substrate including a first discharge region and a first space diving region alternately formed with the first discharge region is formed. A portion of the first discharge region is recessed to form a light transmission portion at the first space dividing region. A second substrate including a second discharge region and a second space dividing region facing the first discharge region and the first space dividing region, respectively, is formed. A partition member that forms a discharge space between the light transmission portion and the second space dividing region is formed. Then, the first and second substrates are assembled such that the light transmission portion makes contact with the partition member.

In an exemplary display apparatus, the display apparatus includes a surface light source device and a display panel. The surface light source device includes a first substrate, a second substrate a ceramic wall and a visible light generating unit. The first substrate has protrusions having wall shape extended in one direction. The second substrate faces the first substrate. The ceramic wall is interposed between the protrusions of the first and second substrates to form a discharge space between the first and second substrates. The visible light generating unit generates a visible light from the discharge space. The display panel converts the visible light into an image light containing information.

According to the present invention, dark lines displayed in a conventional display apparatus due to partition members are converted into bright lines, and the bright lines are diffused by the light diffusing patterns or the light diffusing part. Therefore, a luminance and a uniformity of the luminance are enhanced.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a partially cut out perspective view illustrating a surface light source device according to a first exemplary embodiment of the present invention;

FIG. 2 is a cross-sectional view taken along a line I-I′ in FIG. 1;

FIG. 3 is a plan view illustrating a first substrate in FIG. 1;

FIG. 4 is an enlarged view illustrating a portion ‘B’ in FIG. 2;

FIG. 5 is an enlarged view illustrating a portion ‘C in FIG. 2;

FIG. 6 is an enlarged view illustrating a portion ‘D in FIG. 2;

FIG. 7 is a cross-sectional view illustrating a surface light source device according to a third exemplary embodiment of the present invention;

FIG. 8 is a cross-sectional view illustrating a surface light source device according to a fourth exemplary embodiment of the present invention;

FIG. 9 is a cross-sectional view illustrating a surface light source device according to a fifth exemplary embodiment of the present invention;

FIG. 10 is a cross-sectional view illustrating a surface light source device according to a sixth exemplary embodiment of the present invention;

FIG. 11 is a cross-sectional view illustrating a surface light source device according to a seventh exemplary embodiment of the present invention;

FIG. 12 is an enlarged view illustrating a portion ‘E’ in FIG. 11;

FIG. 13 is a conceptual view illustrating a surface light source device according to an eighth exemplary embodiment of the present invention;

FIGS. 14A to 14C are cross-sectional views illustrating a method of manufacturing a surface light source device according to a ninth exemplary embodiment of the present invention;

FIGS. 15A to 15C are cross-sectional views illustrating a method of manufacturing a surface light source device according to a tenth exemplary embodiment of the present invention; and

FIG. 16 is an exploded and partially cut out perspective view illustrating a display apparatus according to an eleventh exemplary embodiment of the present invention.

### DESCRIPTION OF EMBODIMENTS

Hereinafter, the embodiments of the present invention will be described in detail with reference to the accompanied drawings.

Surface Light Source Device

### Embodiment 1

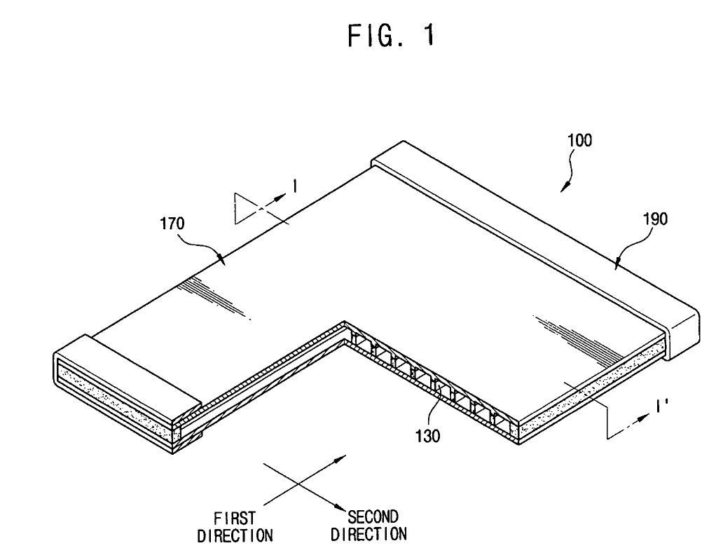

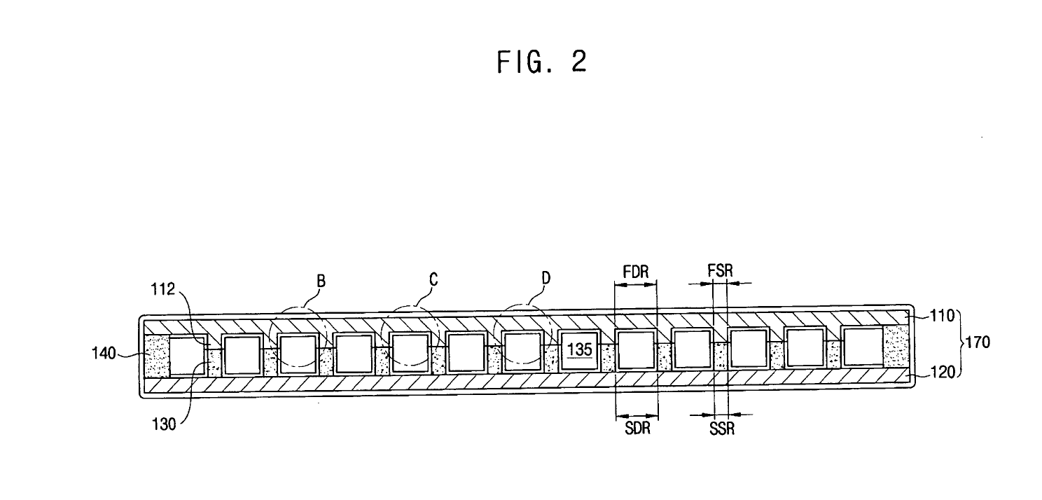

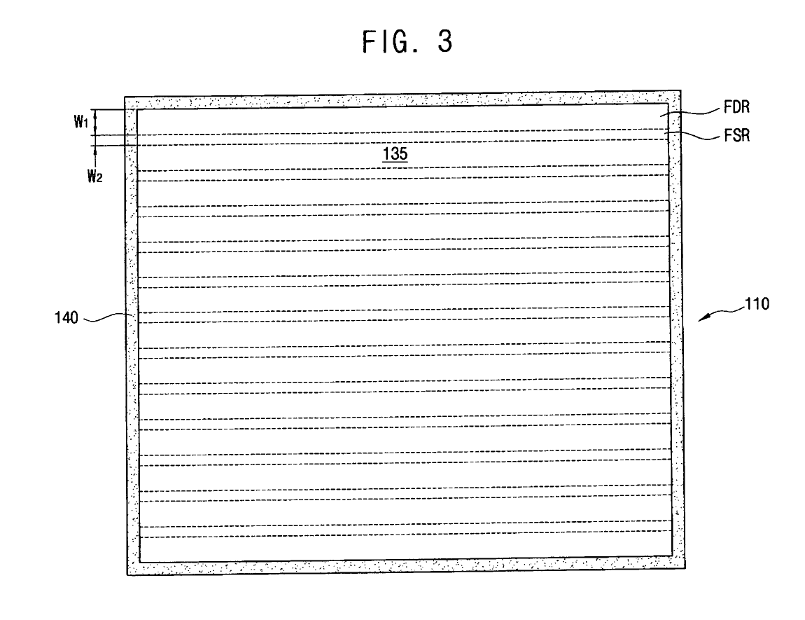

FIG. 1 is a partially cut out perspective view illustrating a surface light source device according to a first exemplary embodiment of the present invention. FIG. 2 is a cross-sectional view taken along a line I-I′ in FIG. 1. FIG. 3 is a plan view illustrating a first substrate in FIG. 1.

Referring to FIGS. 1 to 3, a surface light source device 100 includes a body 170, a partition member 130 and a visible light generating unit 190.

The body 170 includes a first substrate 110 and a second substrate 120.

The first substrate 110 includes a first discharge region FDR, a first space dividing region FSR and a light transmission portion 112. The first substrate 110 corresponds to, for example, a glass substrate.

Referring to FIG. 3, the first discharge region FDR has a rectangular shape having a first width W1. The first discharge region FDR of the first substrate 110 extends in a first direction.

The first space diving region FSR has a rectangular shape having a second width W2. The first space dividing region FDR also extends in the first direction.

The first discharge region FDR and the first space diving region FSR are alternately arranged. The first width W1 of the first discharge region FDR is wider than the second width W2 of the first space diving region FSR.

Referring again to FIG. 2, the light transmission portion 112 is protruded from the first space diving region FSR. In detail, a portion disposed in the first space dividing region FSR of the first substrate 110 is protruded to form the light transmission portion 112 having a wall shape. A height of the light transmission portion 112 is in a range of about 0.5 mm to about 1.0 mm. For example, the light transmission portion 112 includes same material as that of the first substrate 110. Therefore, a visible light may pass through the light transmission portion 112 to eliminate a dark line displayed due to the partition member 130.

The second substrate 120 is disposed such that the second substrate 120 faces the first substrate 110. The second substrate 120 includes a second discharge region SDR and a second space dividing region SSR. The second discharge region SDR corresponds to the first discharge region FDR, and the second space dividing region SSR corresponds to the first space diving region FSR. The second discharge region SDR and the second space diving region SSR are extended in the first direction and disposed such that the second discharge region SDR and the second space diving region SSR alternate with each other. The second substrate 120 may be optically transparent or opaque.

The partition member 130 is interposed between the first space diving region FSR and the second space dividing region SSR. In detail, the partition member 130 is interposed between the light transmission portion 112 of the first space diving region FSR and the second space dividing region SSR. The partition member 130 may include a ceramic material that is hardened by firing and various annex materials for enhancing characteristics of the partition member 130.

The partition member 130 seals the first and second space diving regions FSR and SSR to form a discharge space 135. The partition member 130 may be combined with the light transmission portion 112 through, for example, adhesives.

In order to uniformize pressures of the discharge spaces 135, the partition member may be disposed such that the discharge spaces 135 are connected to each other to have a serpentine shape. Alternatively, the discharge spaces 135 divided by the partition member 130 may be isolated from each other by the partition member 130, and a penetration hole may be formed at the partition member 130 in order to connect the discharge spaces 135 therethrough.

The visible light generating unit 190 applies a discharge voltage to the discharge space 135, so that plasma is generated from the discharge space 135. An invisible light is generated when the plasma having high energy state becomes stable, and the invisible light is converted into a visible light by a fluorescent layer (not shown).

The surface light source device 100 may further include a sealing member 140 interposed between the first and second substrates 110 and 120. The sealing member 140 has a rectangular frame shape having opening at center portion thereof. The sealing member 140 may include same material as that of the first substrate 110 or the second substrate 120. The sealing member 140 forms a vacant space between the first and second substrates 110 and 120 and combines the first and second substrates 110 and 120.

According to the present embodiment, a portion of the first substrate is protruded to form the light transmission portion 112 having wall shape, and the partition member 130 is disposed on the light transmission portion 112. Therefore, a visible light generated from the discharge space 135 exits the surface light source device through the light transmission portion 112 to eliminate a dark line displayed due to the partition member 130. That is, a luminance and a uniformity of the luminance are enhanced.

### Embodiment 2

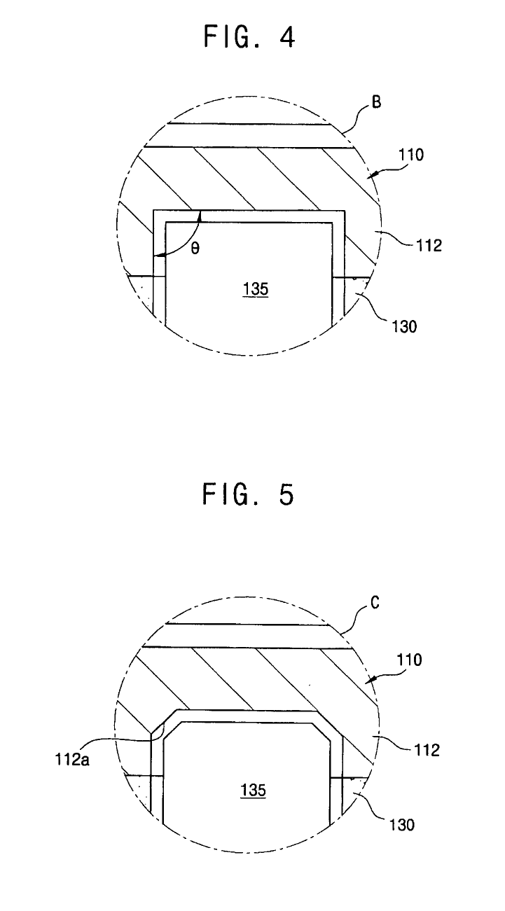

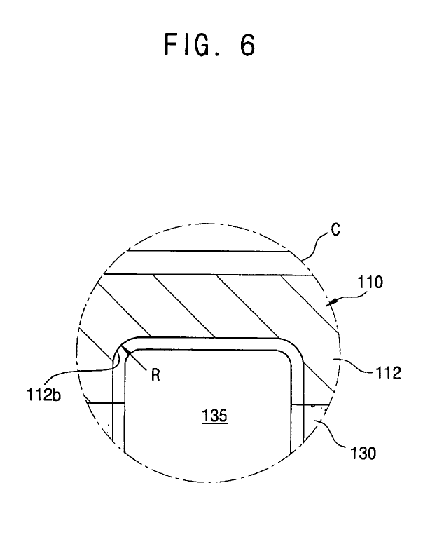

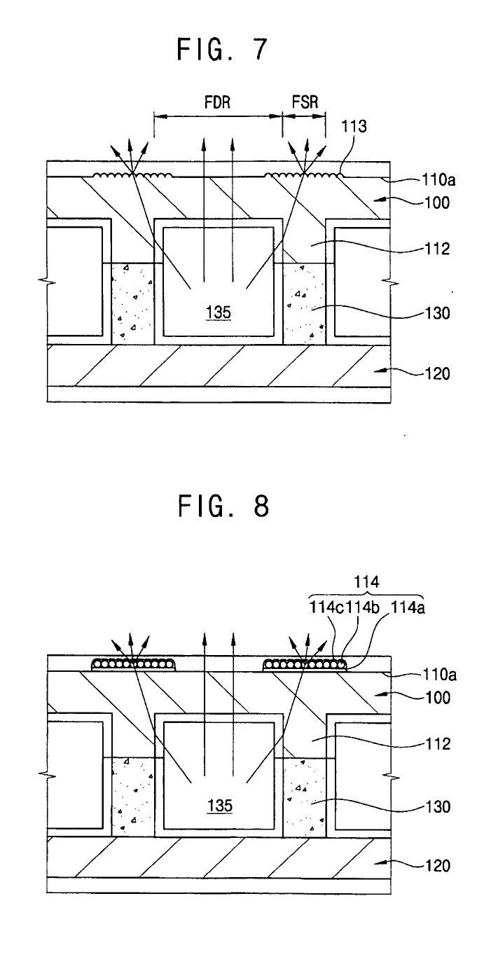

FIG. 4 is an enlarged view illustrating a portion ‘B’ in FIG. 2. FIG. 5 is an enlarged view illustrating a portion ‘C in FIG. 2. FIG. 6 is an enlarged view illustrating a portion ‘D in FIG. 2.

A surface light source device according to a second exemplary embodiment is substantially same as the surface light source device in Embodiment 1 except for a light transmission portion. Therefore, same reference numerals will be used to refer the same or likely parts as those described in Embodiment 1 and any further explanation will be omitted.

Referring to FIG. 4, a side surface of a light transmission portion 112 forms a right angle with respect to a surface of the first substrate 110.

Referring to FIG. 5, a side surface of the light transmission portion 112 is connected to the surface of the first substrate 1 10 through a chamfer portion 112a. An amount of a visible light that exits the surface light source device through the light transmission portion 112 increases due to the chamfer portion 112a. Therefore, amount difference between visible lights exiting the surface light source device through the first space dividing region FSR and the first discharge region FDR is reduced.

Referring to FIG. 6, a side surface of the light transmission portion 112 is connected to the surface of the first substrate 110 through a rounded surface 112b. A visible light may enter the light transmission portion 112 continuously through rounded portion 112b. Therefore, amount difference between visible lights exiting the surface light source device through the first space dividing region FSR and the first discharge region FDR is reduced.

According to the present embodiment, a connecting portion of the light transmission portion 112 and the first substrate 110 has a chamfered shape or a rounded shape. Therefore, amount difference between visible lights exiting the surface light source device through the first space dividing region FSR and the first discharge region FDR is reduced to enhance luminance and uniformity of luminance.

### Embodiment 3

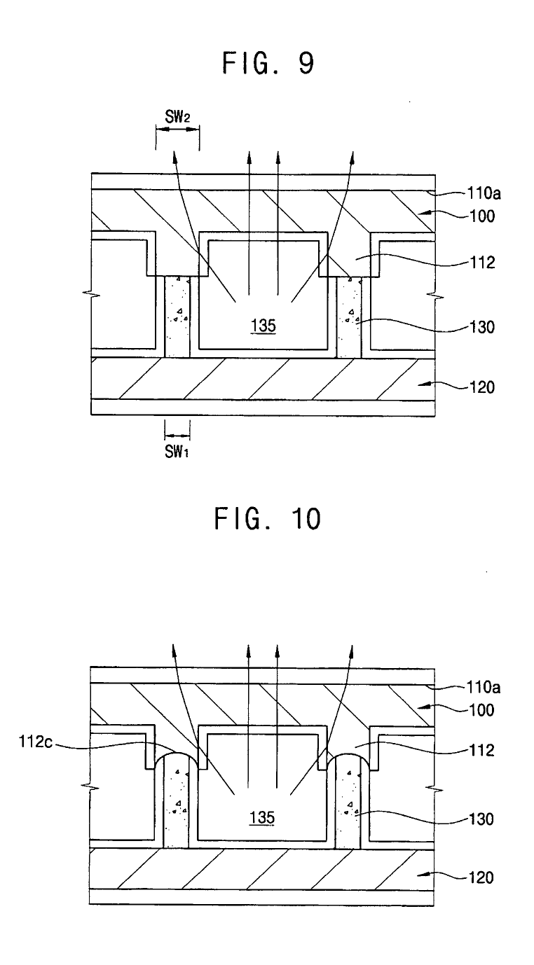

FIG. 7 is a cross-sectional view illustrating a surface light source device according to a third exemplary embodiment of the present invention.

A surface light source device according to a third exemplary embodiment is substantially same as the surface light source device in Embodiment 1 except for a light diffusion pattern. Therefore, same reference numerals will be used to refer the same or likely parts as those described in Embodiment 1 and any further explanation will be omitted.

Referring to FIG. 7, a luminance of a light that exits a surface light source device 100 through a light transmission portion 112 may be different from a luminance of a light that exits the surface light source device 100 through a first discharge region FDR. In detail, an amount of a light that exits the surface light source device 100 through the light transmission portion 112 may be larger than an amount of a light that exits the surface light source device 100 through the first discharge region FDR. Therefore, a luminance of a first space dividing region FSR is higher than a luminance of a first discharge region. In order to compensate the luminance variation, diffusion patterns 113 are formed on a surface corresponding to the light transmission portion 112. The diffusion patterns 113 are formed on, for example, a surface 110a that is opposite to the light transmission portion 112, and each of the diffusion patterns 113 has, for example, a hemispherical shape. A size of each of the diffusion patterns 113 may be different from each other.

The diffusion patterns 113 diffuse a visible light that exits the surface light source device 100 through the light transmission portion 112 to enhance uniformity of luminance.

According to the present embodiment, the diffusion patterns 113 operate as a diffusion sheet or a diffusion plate. Therefore, a number of parts of a surface light source device 100 may be reduced and enhances a luminance and a uniformity of the luminance.

### Embodiment 4

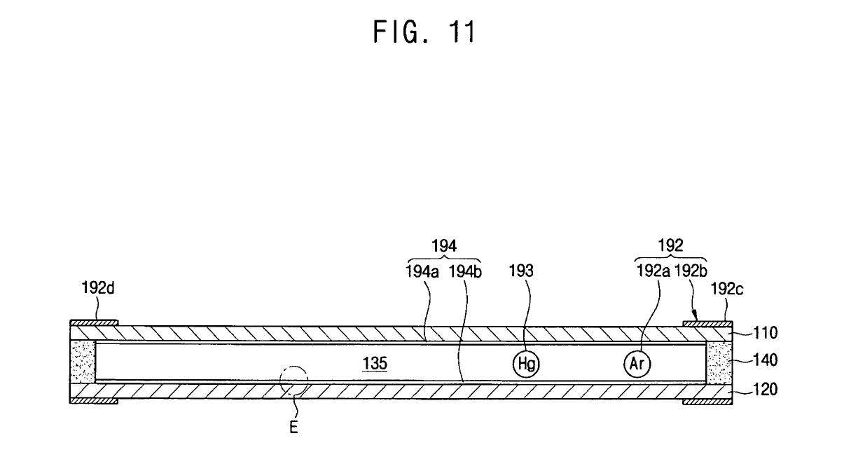

FIG. 8 is a cross-sectional view illustrating a surface light source device according to a fourth exemplary embodiment of the present invention.

A surface light source device according to a fourth exemplary embodiment is substantially same as the surface light source device in Embodiment 1 except for a light diffusion pattern. Therefore, same reference numerals will be used to refer the same or likely parts as those described in Embodiment 1 and any further explanation will be omitted.

Referring to FIG. 8, a luminance of a visible light that exits a surface light source device 100 through a light transmission portion 112 may be different from a luminance of a visible light that exits the surface light source device 100 through a first discharge region FDR. For example, an amount of a visible light that exits the surface light source device 100 through the light transmission portion 112 may be more than an amount of a visible light that exists the surface light source device 100 through the first discharge region FDR. Therefore, a bright line displayed along a first space dividing region FSR in which the light transmission portion 112 is formed.

In order to prevent the bright line, a light diffusing part 114 is disposed on a surface 110a corresponding to the light transmission portion 112. In detail, the light diffusing part 114 is disposed on a portion of the surface 110a of a first substrate 110, and the portion is opposite to the light transmission portion 112.

The light diffusing part 114 includes a base substrate 114a, beads 114b that diffuse a visible light and a binder 114c that combines the beads 114b with the base substrate 114a. A size of the beads 114b may be different from one another.

The light diffusing part 114 diffuses a visible light that exits the surface light source device 100 through the light transmission portion 112 to enhance uniformity of luminance.

According to the present embodiment, the surface light source device 100 includes the light diffusing part 114 that diffuses a visible light. Therefore, a number of the surface light source device 100 may be reduced, and a luminance and a uniformity of the luminance are enhanced.

### Embodiment 5

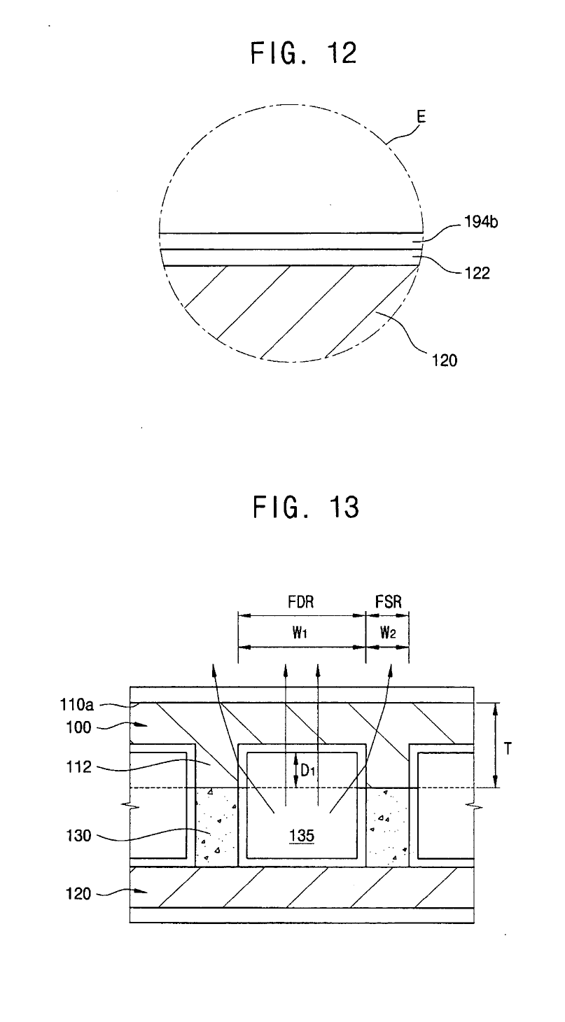

FIG. 9 is a cross-sectional view illustrating a surface light source device according to a fifth exemplary embodiment of the present invention.

A surface light source device according to a fifth exemplary embodiment is substantially same as the surface light source device in Embodiment 1 except for a partition member. Therefore, same reference numerals will be used to refer the same or likely parts as those described in Embodiment 1 and any further explanation will be omitted.

Referring to FIG. 9, a partition member 130 has a first width SW1, and a light transmission portion 112 has a second width SW2. The first width SW1 is narrower than the second width SW2. Therefore, a dark region displayed in a first space dividing region FSR and caused by misalignment of the partition member 130 and the light transmission portion 112 is prevented.

According to the present embodiment, the first width SW1 of the partition member 130 is narrower than the second width SW2 of the light transmission section 112 to form a marginal space that compensates misalignment between the partition member 130 and the light transmission section 112. Therefore, a uniformity of the luminance is enhanced.

### Embodiment 6

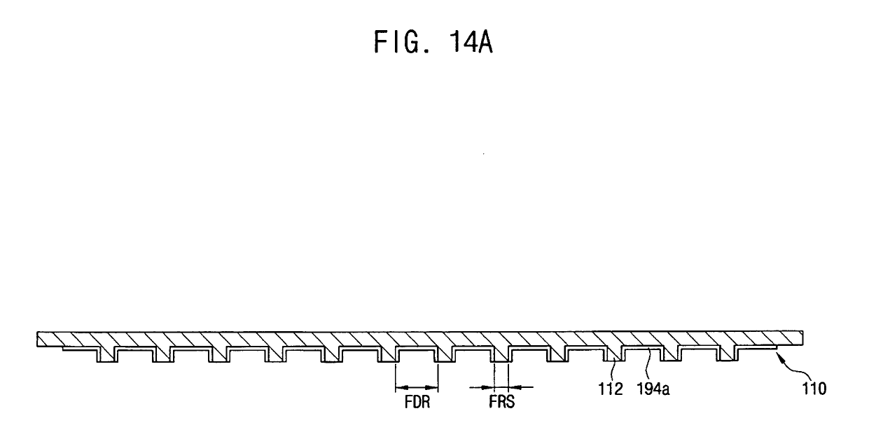

FIG. 10 is a cross-sectional view illustrating a surface light source device according to a sixth exemplary embodiment of the present invention.

A surface light source device according to a sixth exemplary embodiment is substantially same as the surface light source device in Embodiment 1 except for a light transmission section. Therefore, same reference numerals will be used to refer the same or likely parts as those described in Embodiment 1 and any further explanation will be omitted.

Referring to FIG. 10, a light transmission portion 112 has a concave contact face 112c. The concave contact face 112c of the light transmission portion 112 makes contact with a partition member 130. The concave contact face 112c may have any curvature as long as the concave contact face 112c corresponds to the partition member 130.

When the partition member 130 makes contact with the concave contact face 112c during assemblage, the partition member 130 slides toward a center of the concave contact face 112c of the light transmission portion 112. Therefore, misalignment between the light transmission portion 112 and the partition member 130 is prevented.

According to the present embodiment, the light transmission portion 112 has the concave contact face 112c that makes contact with the partition member 130. Therefore, the misalignment between the light transmission portion 112 and the partition member 130 is prevented. Therefore, non-uniformity of luminance is also prevented.

### Embodiment 7

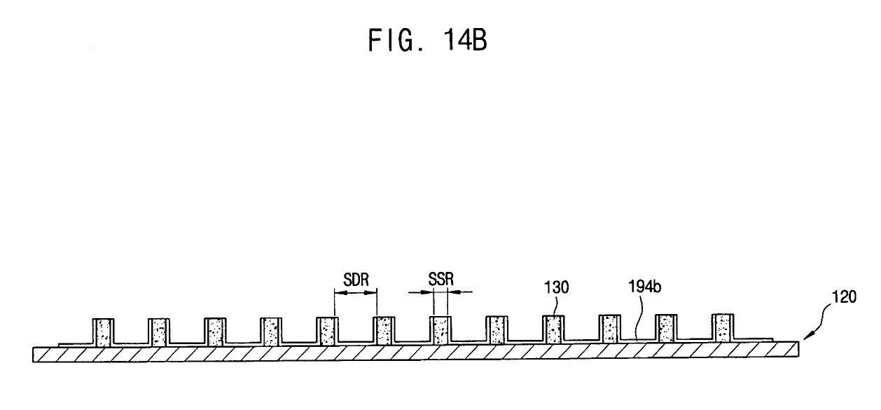

FIG. 11 is a cross-sectional view illustrating a surface light source device according to a seventh exemplary embodiment of the present invention.

A surface light source device according to a seventh exemplary embodiment is substantially same as the surface light source device in Embodiment 1 except for a visible light generating unit. Therefore, same reference numerals will be used to refer the same or likely parts as those described in Embodiment 1 and any further explanation will be omitted.

Referring to FIG. 11, a visible light generating unit 190 includes a plasma generating unit 192, an invisible light generating gas 193 and a fluorescent member 194.

The plasma generating unit 192 includes a pair of electrodes 192b and a plasma gas 192a. The plasma generating unit 192 generates plasma from the plasma gas 192a in the discharge space 135 between the first and second substrates 110 and 120.

The electrodes 192b include a first electrode 192c and a second electrode 192d. The first and second electrodes 192c and 192d are disposed outside of the discharge space 135. Alternatively, the first and second electrodes 192c and 192d may be disposed inside the discharge space 135. However, when the first and second electrodes 192c and 192d are disposed inside the discharge space 135, driving voltage and power consumption may be reduced. First and second driving voltages are applied to the first and second electrodes 192c and 192d, respectively. A voltage difference between the first and second driving voltages is enough to emit electrons. The electrons convert the plasma gas 192a into plasma state.

Inert gas, for example argon (Ar) gas may be employed as the plasma gas 192a.

The invisible light generating gas 193 is disposed together with the plasma gas 192a in the discharge space 135. When atoms of the invisible light generating gas 193 collide with electrons, the invisible light generating gas 193 generates an invisible light such as an ultraviolet light. A mercury gas may be employed as the invisible light generating gas 193. Alternatively, other gas may be used.

A fluorescent member 194 includes first and second fluorescent layers 194a and 194b. The first fluorescent layer 194a is disposed in a first discharge region FDR of the discharge space 135. The second fluorescent layer 194b is disposed in a second discharge region SDR of the discharge space 135. The first and second fluorescent layers 194a and 194b convert the invisible light into a visible light.

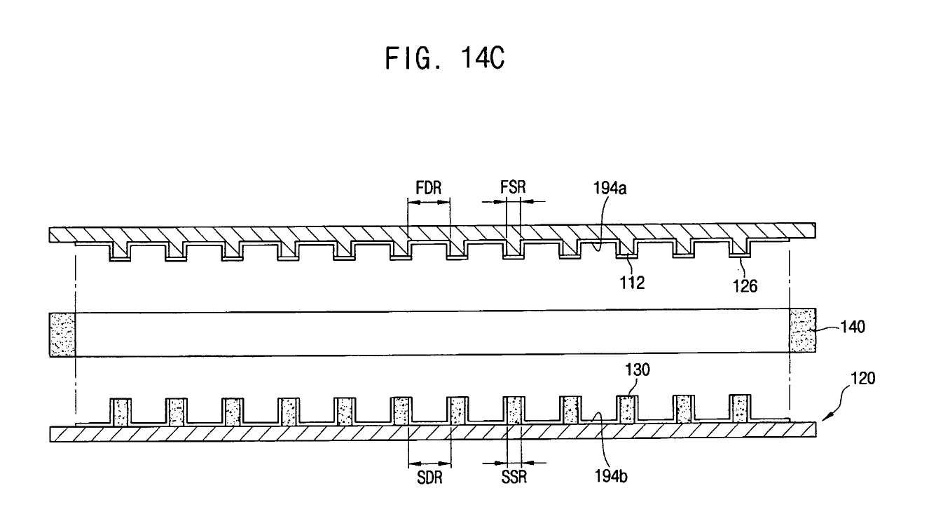

FIG. 12 is an enlarged view illustrating a portion ‘E’ in FIG. 11.

Referring to FIG. 12, the visible light generating unit (not shown) may further include a light reflecting layer 122. The light reflecting layer 122 is interposed between the second fluorescent layer 194b and the second substrate 120. For example, titanium oxide or aluminum oxide may be employed as the light reflecting layer 122.

### Embodiment 8

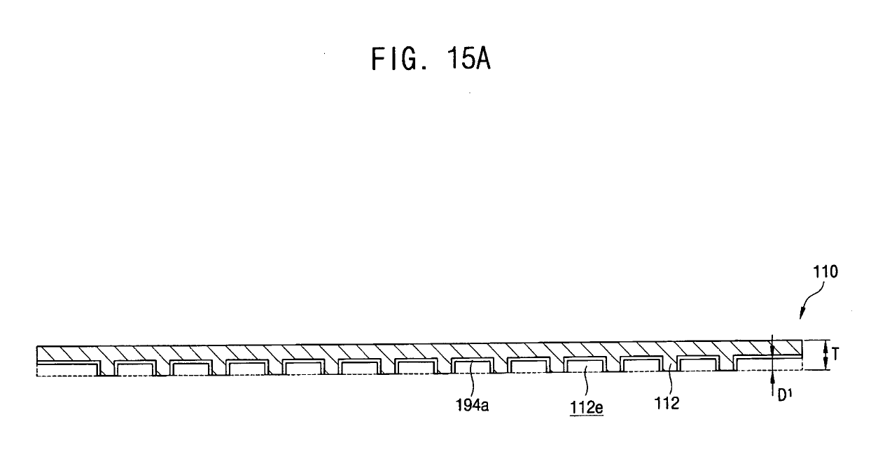

FIG. 13 is a conceptual view illustrating a surface light source device according to an eighth exemplary embodiment of the present invention.

A surface light source device according to an eighth exemplary embodiment is substantially same as the surface light source device in Embodiment 1 except for a first substrate. Therefore, same reference numerals will be used to refer the same or likely parts as those described in Embodiment 1 and any further explanation will be omitted.

A first substrate 110 includes a first discharge region FDR, a first space dividing region FSR and a light transmission portion 112. A glass substrate may be used as the first substrate 110. The first substrate 110 has a thickness ‘T’.

The first discharge region FDR has a rectangular shape having a first width W1, and is extended in the first direction.

The first space dividing region FSR has a rectangular shape having a second width W2, and is extended also in the first direction.

The first discharge region FDR and the first space dividing region FSR are alternately disposed in the second direction. The first width W1 of the first discharge region FDR is wider than the second width W2 of the first space dividing region FSR.

A portion of the first substrate 110 is recessed by a depth D1 to form the light transmission portion 112. The depth D1 is smaller than the thickness T. A recessed portion 112e may be formed through many methods, for example such as sand blast, erosion by hydrogen fluoride, heating and pressing, etc.

According to the present embodiment, a portion of the first substrate 110 is recessed to form the recessed portion 112e. Therefore, the light transmission portion 112 corresponding to a remaining portion is formed. The partition member 130 is disposed on the light transmission portion 112. A visible light of the discharge space 135 exits the surface light source device through the light transmission portion 112. Therefore, a dark line due to the partition member 130 is removed to enhance a luminance and a uniformity of the luminance.

Method of Manufacturing a Surface Light Source Device

### Embodiment 9

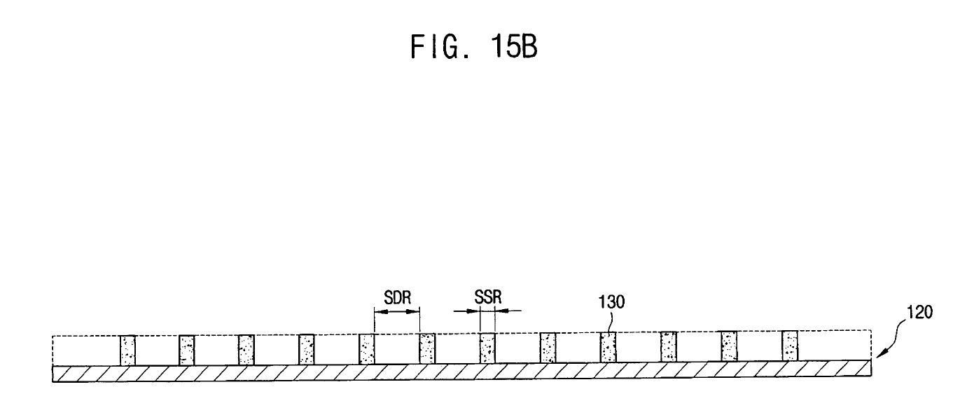

FIGS. 14A to 14C are cross-sectional views illustrating a method of manufacturing a surface light source device according to a ninth exemplary embodiment of the present invention.

FIG. 14A is a cross-sectional view illustrating a first substrate manufactured by a ninth exemplary embodiment of the present invention.

Referring to FIG. 14A, in order to manufacture a surface light source device, a first substrate 110 is manufactured at first. For example, the first substrate 110 may be manufactured through an injection molding.

A first discharge region FDR and a first space dividing region FSR are alternately formed on the first substrate 110. A light transmission portion 112 is integrally formed with the first substrate 110 in the first space diving region FSR. A connection portion between the light transmission portion 112 and the first substrate 110 may form a right angle, or correspond to a chamfered portion or a rounded portion.

Then, a first fluorescent layer 194a is formed on the first discharge region FDR of the first substrate 110. The first fluorescent layer 194a may be formed by spraying a fluorescent material that is in a liquid state. The first fluorescent layer 194a may be formed not only in the first discharge region FDR but also at a side surface of the light transmission portion 112.

FIG. 14B is a cross-sectional view illustrating a second substrate manufactured by an exemplary embodiment of the present invention.

Referring to FIG. 14B, a second discharge region SDR and a second space dividing region SSR are alternately formed on the second substrate 120. The second discharge region SDR corresponds to the first discharge region FDR of the first substrate 110, and the second space dividing region SSR corresponds to the first space dividing region FSR of the first substrate 110.

A partition member 130 is formed in the second space dividing region SSR. The partition member 130 may include an opaque ceramic material that is hardened by firing.

A second fluorescent layer 194b is formed in the second discharge region SDR of the second substrate 120. The second fluorescent layer 194b may be formed by spraying a fluorescent material that is in a liquid state. The second fluorescent layer 194b may be formed not only in the second discharge region SDR but also at a side surface of the partition member 130.

FIG. 14C is a cross-sectional view illustrating a process of assembling the first and second substrates.

Referring to FIG. 14C, the first and second substrates 110 and 120 are assembled by a sealing member 140. The sealing member 140 and the first and second substrates 110 and 120 form a discharge space.

The light transmission portion 112 of the first substrate 110 makes contact with the partition member 130 of the second substrate 120. The light transmission portion 112 may be adhered to the partition member 130 by an adhesive.

Then, the first and second electrodes are formed on the first and second substrates 110 and 120, and the plasma gas and the invisible light generating gas are injected into the space 135 formed between the first and second substrates 110 and 120. Therefore, the surface light source device is completed.

According to the present embodiment, a sequence of forming the first and second substrates 110 and 120 may be changed. That is, the second substrate 120 may be formed prior to the first substrate 110.

Furthermore, the method of forming the surface light source device may further include a process of forming the diffusion pattern or the light diffusing part that diffuses a visible light emitted from the light transmission portion 112.

### Embodiment 10

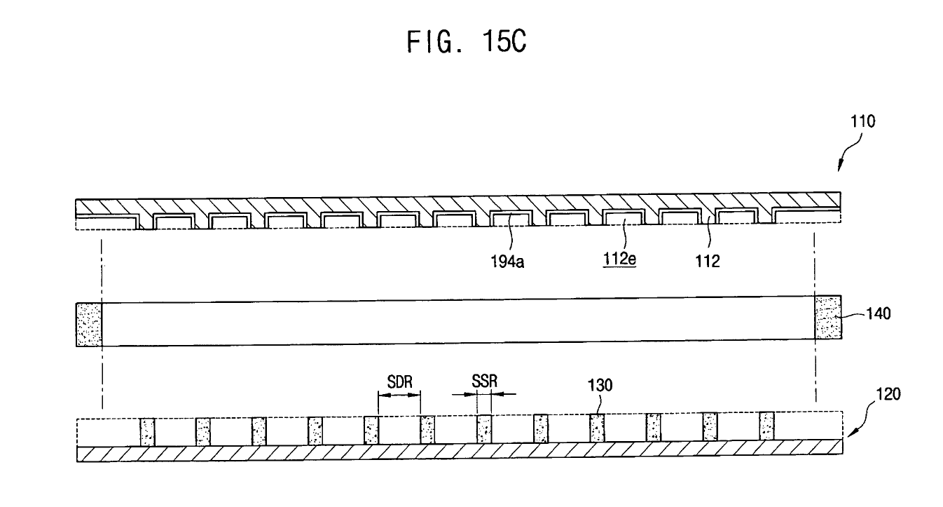

FIGS. 15A to 15C are cross-sectional views illustrating a method of manufacturing a surface light source device according to a tenth exemplary embodiment of the present invention.

FIG. 15A is a cross-sectional view illustrating a first substrate manufactured by a tenth exemplary embodiment of the present invention.

Referring to FIG. 15A, in order to manufacture a surface light source device, a first substrate 110 is first manufactured. For example, the first substrate 110 may be manufactured through an injection molding.

A first discharge region FDR and a first space dividing region FSR are alternately formed on the first substrate 110. A recessed portion 112e is formed in the first discharge region FDR of the first substrate 110 through sand blast, erosion by hydrogen fluoride or heating and pressing. Therefore, the first substrate 110 has a thickness ‘T’, and the recessed portion 112e has a depth D1 that is smaller than the thickness T.

By forming the recessed portion 112e in the first discharge region FDR, a light transmission portion 112 is formed in the first space dividing region FSR and a discharge space 135 is formed in the first discharge region FDR.

A connection portion between the light transmission portion 112 and the first substrate 110 may form a right angle, or correspond to a chamfered portion or a rounded portion.

Then, a first fluorescent layer 194a is formed on a bottom surface of the recessed portion 112e that is formed in the first discharge region FDR of the first substrate 110. The first fluorescent layer 194a may be formed by spraying a fluorescent material that is in a liquid state. The first fluorescent layer 194a may be formed not only in the first discharge region FDR but also at a side surface of the recessed portion 112e.

FIG. 15B is a cross-sectional view illustrating a second substrate manufactured by an exemplary embodiment of the present invention.

Referring to FIG. 15B, a second discharge region SDR and a second space dividing region SSR are alternately formed on the second substrate 120. The second discharge region SDR corresponds to the first discharge region FDR of the first substrate 110, and the second space dividing region SSR corresponds to the first space dividing region FSR of the first substrate 110.

The partition member 130 is formed in the second space dividing region SSR. The partition member 130 may include an opaque ceramic material that is hardened by firing.

The second fluorescent layer 194b is formed in the second discharge region SDR of the second substrate 120. The second fluorescent layer 194b may be formed by spraying a fluorescent material that is in a liquid state. The second fluorescent layer 194b may be formed not only in the second discharge region SDR but also at a side surface of the partition member 130.

FIG. 15C is a cross-sectional view illustrating a process of assembling the first and second substrates.

Referring to FIG. 15C, the first and second substrates 110 and 120 are assembled by a sealing member 140. The sealing member 140 and the first and second substrates 110 and 120 form the discharge space.

The light transmission portion 112 of the first substrate 110 makes contact with the partition member 130 of the second substrate 120. The light transmission portion 112 may be adhered to the partition member 130 by an adhesive.

Then, the first and second electrodes are formed on the first and second substrates 110 and 120, and the plasma gas and the invisible light generating gas are introduced into the space 135 formed between the first and second substrates 110 and 120. Therefore, the surface light source device is completed.

The method of forming the surface light source device may further include a process of forming the diffusion pattern or the light diffusing part that diffuses a visible light emitted from the light transmission portion 112.

Display Apparatus

### Embodiment 11

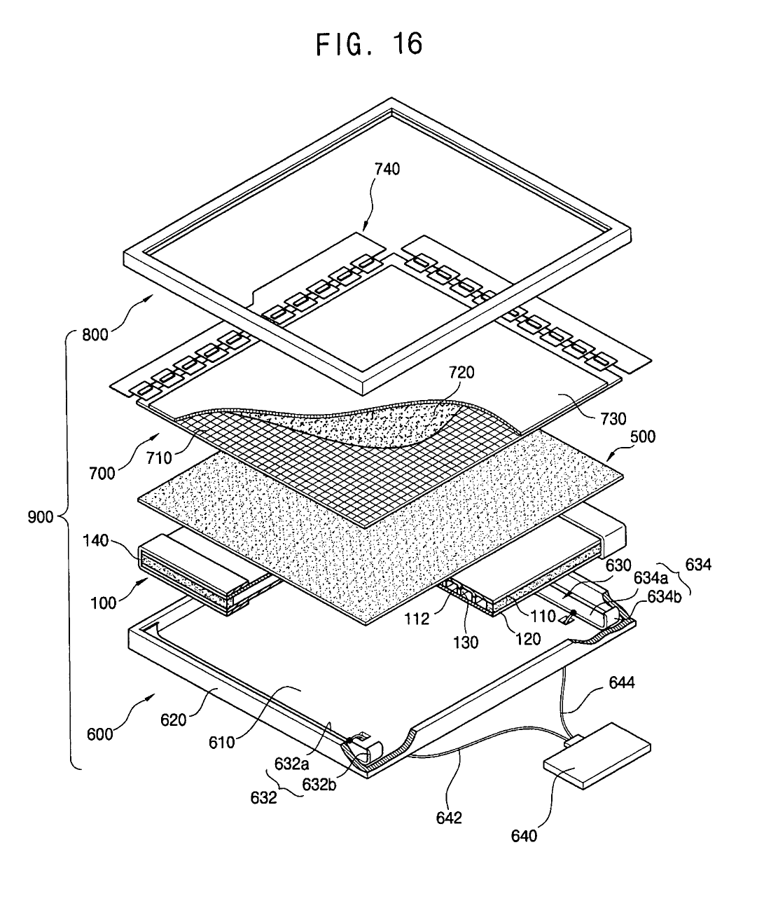

FIG. 16 is an exploded and partially cut out perspective view illustrating a display apparatus according to an eleventh exemplary embodiment of the present invention.

A surface light source device of a display apparatus according to an eleventh exemplary embodiment is substantially same as the surface light source devices that is one of Embodiments 1 to 10. Therefore, same reference numerals will be used to refer the same or likely parts as those described in Embodiments 1 to 10 and any further explanation will be omitted.

Referring to FIG. 16, a display apparatus according to an eleventh exemplary embodiment of the present invention includes a receiving container 600, a surface light source device 100, a display panel 700 and a chassis 800.

The receiving container 600 includes a bottom plate 610, sidewalls 620, a discharge voltage applying module 630 and an inverter 640. The sidewalls 620 are disposed at edges of the receiving container 600, so that the bottom plate 610 and the sidewalls 620 form a receiving space. The receiving container 600 fixes the surface light source device 100 and the display panel 700.

The bottom plate 610 has substantially identical shape as the surface light source device 100 to receive the surface light source device 100. For example, the bottom plate 610 and the surface light source device 100 have a rectangular shape.

The sidewalls 620 are extended upwardly from the bottom plate to fix the surface light source device 100.

The discharge voltage applying module 630 applies a discharge voltage to a pair of electrodes 192b of the surface light source device 100. The discharge voltage applying module 630 includes first and second discharge voltage applying modules 632 and 634. The first discharge voltage applying module 632 includes a first conducting body 632a and a first conducting clip 632b that is integrally formed with the first conducting body 632a. The second discharge voltage applying module 634 includes a second conducting body 634a and a second conducting clip 634b that is integrally formed with the second conducting body 634a.

The electrodes 192b are fixed by combining with the first and second conducting clips 632b and 634b, respectively.

The inverter 640 applies discharge voltage to the first and second discharge voltage applying modules 632 and 634. A first wiring 642 electrically connects the inverter 640 to the first discharge voltage applying module 632 and a second wiring 644 electrically connects the inverter 640 to the second discharge voltage applying module 634.

The inverter 640 applies the discharge voltage to the surface light source device 100 through the first and second discharge voltage applying modules 632 and 634. Alternatively, the inverter 640 may apply the discharge voltage directly to the surface light source device 100.

The display panel 700 converts a light generated from the surface light source device 100 into an image. The display panel 700 includes a thin film transistor (TFT) substrate 710, a liquid crystal layer 720, a color filter substrate 730 and a driver module 740.

The TFT substrate 710 includes pixel electrodes arranged in a matrix shape, TFTs, gate lines and data lines. The driving voltage is applied to the pixel electrodes through the TFTs.

The color filter substrate 730 includes color filters facing the pixel electrodes of the TFT substrate 710, and a common electrode formed on the color filters.

The liquid crystal layer 720 is interposed between the TFT substrate 710 and the color filter substrate 730.

The chassis 800 enwraps an edge portion of the color filter substrate 730, and is combined with the receiving container 600 by a hook. The chassis 800 protects the display panel 700, and prevents the display panel 700 from being separated from the receiving container 600.

The display apparatus may further include an optical property enhancing member 550.

According to the present invention, dark lines displayed in a conventional display apparatus due to partition members are converted into bright lines, and the bright lines are diffused by the light diffusing patterns or the light diffusing part. Therefore, a luminance and a uniformity of the luminance are enhanced.

Having described the exemplary embodiments of the present invention and its advantages, it is noted that various changes, substitutions and alterations can be made herein without departing from the spirit and scope of the invention as defined by appended claims.

1. A surface light source device comprising:
a body including first and second substrates facing each other, the first substrate having a first discharge region, a first space diving region alternately formed with the first discharge region and a light transmission portion protruded from the first space dividing region, and the second substrate having a second discharge region and a second space dividing region facing the first discharge region and the first space dividing region, respectively;
a partition member interposed between the first and second substrates to form a discharge space between the first and second substrates; and
a visible light generating unit that generates a visible light from the body.

2. The surface light source device of claim 1, further comprising a sealing member combining the first and second substrates to seal a space between the first and second substrates.

3. The surface light source device of claim 1, wherein the first substrate comprises an optically transparent material, and the light transmission portion has substantially same optical transmittance as an optical transmittance of the first substrate.

4. The surface light source device of claim 1, wherein a connection portion between the light transmission portion and the first substrate forms a right angle.

5. The surface light source device of claim 1, wherein the light transmission portion is connected to the first substrate through a chamfered portion.

6. The surface light source device of claim 1, wherein the light transmission portion is connected to the first substrate through a rounded portion.

7. The surface light source device of claim 1, wherein the first substrate includes light diffusion patterns formed in a region corresponding to the first space dividing region.

8. The surface light source device of claim 1, further comprising a light diffusing part disposed in the first space dividing region of the first substrate.

9. The surface light source device of claim 1, wherein the space dividing member has a first width that is narrower than a second width of the first space dividing region.

10. The surface light source device of claim 1, wherein the light transmission portion has a concave surface, and the partition member has a convex surface corresponding to the concave surface of the light transmission portion to prevent misalignment.

11. The surface light source device of claim 1, wherein the partition member is adhered to the light transmission portion by an adhesive.

12. The surface light source device of claim 1, the visible light generating unit comprises:
a plasma generating unit that generates plasma in the discharge space;
an invisible light generating gas that generates an invisible light by the plasma generated by the plasma generating unit; and
a fluorescent member that converts the invisible light into a visible light.

13. The surface light source device of claim 12, wherein the plasma generating unit comprises:
a pair of electrodes disposed on an outer surface of the body; and
a plasma gas disposed inside the discharge space and transformed into plasma by a driving voltage applied to the electrodes.

14. The surface light source device of claim 12, wherein the invisible light generating gas includes a mercury gas emitting the invisible light by the plasma.

15. The surface light source device of claim 12, wherein the fluorescent member comprises a first fluorescent layer disposed in the first discharge region of the first substrate and a second fluorescent layer disposed in the second discharge region of the second substrate.

16. The surface light source device of claim 15, wherein the body further comprises a light reflecting layer interposed between the second fluorescent layer and the second substrate.

17. A surface light source device comprising:
a body including first and second substrates facing each other, the first substrate having a first discharge region and a first space diving region alternately formed with the first discharge region, the first discharge region being recessed to form a light transmission portion at the first space dividing region, and the second substrate having a second discharge region and a second space dividing region facing the first discharge region and the first space dividing region, respectively;
a partition member interposed between the first and second substrates to form a discharge space between the first and second substrates; and
a visible light generating unit that generates a visible light from the body.

18. A method of manufacturing a surface light source device, comprising:
forming a first substrate including a first discharge region, a first space diving region alternately formed with the first discharge region and a light transmission portion protruded from the first space dividing region;
forming a second substrate including a second discharge region and a second space dividing region facing the first discharge region and the first space dividing region, respectively;
forming a partition member that forms a discharge space between the light transmission portion and the second space dividing region; and
assembling the first and second substrates such that the light transmission portion makes contact with the partition member.

19. The method of claim 18, further comprising forming a first fluorescent layer on a surface of the first substrate such that the first fluorescent layer faces the second substrate.

20. The method of claim 18, further comprising forming a second fluorescent layer on a surface of the second substrate such that the second fluorescent layer faces the first substrate.

21. The method of claim 18, further comprising forming electrodes on a surface of the first and second substrates.

22. The method of claim 18, wherein the first substrate having the light transmission portion is formed through an injection molding.

23. The method of claim 18, further comprising forming light diffusing patterns on a surface corresponding to the first space dividing region.

24. The method of claim 18, further comprising disposing a light diffusing part on a surface corresponding to the first space dividing region.

25. A method of forming a surface light source device, comprising:
forming a first substrate including a first discharge region and a first space diving region alternately formed with the first discharge region, a portion of the first discharge region being recessed to form a light transmission portion at the first space dividing region;
forming a second substrate including a second discharge region and a second space dividing region facing the first discharge region and the first space dividing region, respectively;
forming a partition member that forms a discharge space between the light transmission portion and the second space dividing region; and
assembling the first and second substrates such that the light transmission portion makes contact with the partition member.

26. The method of claim 25, further comprising forming a first fluorescent layer on the portion that is recessed.

27. The method of claim 25, further comprising forming a second fluorescent layer on a surface of the second substrate such that the second fluorescent layer faces the first substrate.

28. The method of claim 25, further comprising forming electrodes on a surface of the first and second substrates.

29. The method of claim 25, wherein the portion is recessed by sand blast, erosion by hydrogen fluoride or heating and pressing.

30. The method of claim 25, further comprising forming light diffusing patterns on a surface corresponding to the portion that is recessed.

31. The method of claim 25, further comprising disposing a light diffusing part on a surface corresponding to the portion that is recessed.

32. A display apparatus comprising:
a surface light source device including:
a first substrate having protrusions having wall shape extended in one direction;
a second substrate facing the first substrate;
a ceramic wall interposed between the protrusions of the first substrate and the second substrate to form a discharge space between the first and second substrates; and
a visible light generating unit that generates a visible light from the discharge space; and
a display panel that converts the visible light into an image light containing information.
